(19) United States
(12) Patent Application Publication
(10) Pub. No.: US 2019/0152063 A1
(43) Pub. Date: May 23, 2019

(54) MULTI-JOINTED ROBOT

(71) Applicant: GROOVE X, Inc., Tokyo (JP)

(72) Inventor: Kaname HAYASHI, Tokyo (JP)

(21) Appl. No.: 16/254,540

(22) Filed: Jan. 22, 2019

Related U.S. Application Data
(63) Continuation of application No. PCT/JP2017/026415, filed on Jul. 21, 2017.

(30) Foreign Application Priority Data
Jul. 26, 2016 (JP) 2016-146240

(51) Int. Cl. B25J 9/16; B25J 9/08; B25J 9/06; B25J 17/02

(52) U.S. Cl. CPC B25J 9/1697; B25J 17/025; B25J 9/065; B25J 9/08

(57) ABSTRACT

A robot is obtained by a multiple of arm units being continuously connected. Interlocked arm units have mutually coaxial and perfectly circular end faces in a connection portion thereof. One arm unit drives another arm unit so as to rotate centered on an axial line of the connection portion. The robot may include a unit having a curved external form as the arm unit.

### RELATED APPLICATIONS

The present application is a continuation of International Application No. PCT/JP2017/026415, filed Jul. 21, 2017, which claims priority from Japanese Application No. 2016-146240, filed Jul. 26, 2016, the disclosures of which applications are hereby incorporated by reference herein in their entirety.

### BACKGROUND OF THE INVENTION

### Field of the Invention

The present invention relates to a multi-jointed robot configured by arm units being continuously connected.

### Description of the Background Art

A multi-jointed robot configured by a multiple of arm units being continuously connected, such as an industrial robot, is widely known (for example, refer to JP-A-2007-144559). A multi-jointed robot installed in a production line can reliably and accurately carry out individually set work by being freely driven at continuously connected portions thereof. Also, technology such that a multi-jointed robot is utilized as a device that supplements a human motor function has also been proposed (for example, refer to JP-A-2008-55544).

This kind of robot always has a high degree of freedom, but design is basically carried out so that the robot can extend to be perfectly straight. Because of this, the configuration of JP-A-2007-144559 is such that when there is a rotary shaft vertical to opposing faces of a unit in a joint portion, the rotary shaft cannot be positioned in a center of the opposing faces. Because of this, a radial direction change of form occurs in a connection portion of the unit when the unit rotates. In the case of an industrial robot, an operator is unlikely to approach when the robot is operating, because of which the possibility of the change of form being a problem is low. However, when configuring as a robot such that operates in a vicinity of a user, there is concern that a body or clothing of the user will interfere with a joint portion of the robot. Also, the configuration of JP-A-2008-55544 has a rotary shaft parallel to opposing faces of a unit in a joint portion. Because of this, bending occurs in the joint portion of the unit when the robot is driven, and there is concern that a body or clothing of a user will interfere with the joint portion. Because of this, extreme care needs to be taken when operating with either configuration.

Also, a multi-jointed robot increases in length the greater the number of joints thereof, and there is room for improvement in terms of energy efficiency in that power consumption increases regardless of work details, and the like.

### SUMMARY OF THE INVENTION

The invention having been completed based on a recognition of the heretofore described problems, one object thereof is to provide technology that can prevent or restrict interference between a joint portion of a multi-jointed robot and an exterior. Also, one more object of the invention is to increase energy efficiency of the multi-jointed robot.

A multi-jointed robot in an aspect of the invention is obtained by a multiple of arm units being continuously connected. Interlocked arm units have mutually coaxial and perfectly circular end faces in a connection portion thereof. One arm unit drives another arm unit so as to rotate centered on an axial line of the connection portion.

A multi-jointed robot in another aspect of the invention is obtained by a multiple of arm units being continuously connected, and a utility unit is mounted on a leading end arm unit. The utility unit includes a camera and a lighting device. Interlocked arm units freely and relatively rotate centered on a rotary shaft provided in a connection portion thereof. One arm unit incorporates a drive mechanism for driving the other arm unit so as to rotate. The multiple of arm units are controlled so that the utility unit irradiates a moving object forming an irradiation target with light while tracking the moving object with the camera.

A multi-jointed robot in still another aspect of the invention is obtained by three or more arm units being continuously connected. A multiple of the arm units are drive arm units incorporating a drive mechanism for driving an arm unit to which the arm unit is connected, a battery that supplies power to the drive mechanism, and a power supply circuit for charging the battery.

According to aspects of the invention, technology such that interference between a joint portion of a multi-jointed robot and an exterior is prevented or restricted can be provided.

### BRIEF DESCRIPTION OF THE DRAWINGS

FIGS. 1A and 1B are drawings representing an external appearance of a robot according to an embodiment;

FIGS. 2A to 2C are drawings representing an external appearance of a unit;

FIG. 3 is a sectional view along an A-A arrow of FIG. 2B;

FIGS. 4A to 4C are sectional views representing a connection structure of the unit;

FIGS. 5A and 5B are schematic views representing a connection structure of the whole robot;

FIG. 6 is a functional block diagram of a robot device;

FIGS. 7A and 7B are drawings schematically representing a method of controlling the robot;

FIG. 8 is a drawing representing further details of the method of controlling the robot;

FIG. 9 is a drawing representing an interference avoidance map used in a control computing process;

FIG. 10 is a diagram representing an example of using the robot;

FIGS. 11A to 11C are drawings representing one example of a method of controlling movement of the robot;

FIGS. 12A to 12D are drawings schematically showing a configuration of a robot according to modified examples; and

FIGS. 13A and 13B are drawings schematically representing a configuration and a control method of a robot according to a modified example.

### DETAILED DESCRIPTION OF THE INVENTION

Hereafter, an embodiment of the invention will be described in detail, with reference to the drawings. For the sake of convenience, a positional relationship between structures may be expressed with a state shown in the drawings as a reference in the following description. Also, in the following embodiment and modified examples thereof, the same reference signs are allotted to components that are practically identical, and a description thereof is omitted as appropriate.

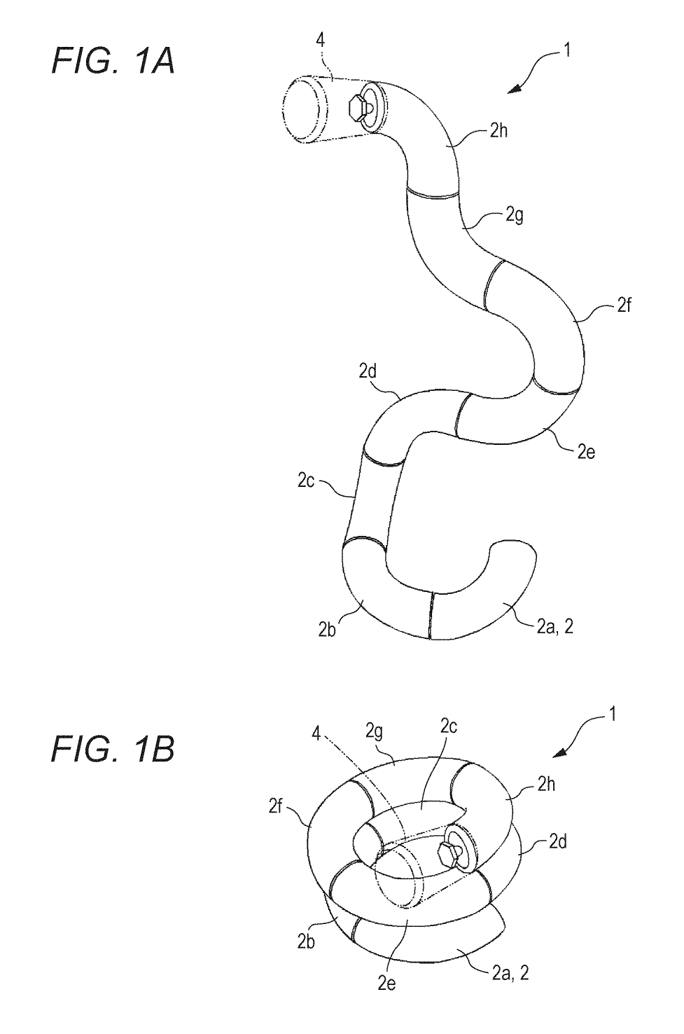

FIGS. 1A and 1B are drawings representing an external appearance of a robot 1 according to the embodiment. FIG. 1A shows an extended posture of the robot 1, and FIG. 1B shows a contracted posture.

The robot 1 is a multi-jointed robot obtained by a multiple of arm units (hereafter also referred to simply as “units”) being continuously connected in front and behind. In this embodiment, first to eighth units 2a to 2h (referred to as “units 2” when not particularly distinguishing) are connected from a base end side toward a leading end side. The robot 1 can realize various postures by causing units 2 connected front to back to be relatively displaced in accordance with a command from an external control device to be described hereafter.

Each unit 2 drives the unit 2 immediately in front based on a control command from the external control device. In this embodiment, all the units 2 have the same structure, and are assumed to be “general-purpose units” that can be interchanged as appropriate. Each unit 2 is identified by ID individually set in advance. In this embodiment, basically, a position of the first unit 2a is taken as a reference position when calculating a position and a posture of the robot 1. Also, connection relationships and ID of the units 2 are determined in advance.

A utility unit 4 is attached to a leading end of the eighth unit 2h. The utility unit 4 is a target device in accordance with an application of the robot 1, and is a lighting device (for example, a light emitting diode (LED)) in this embodiment. By the first to eighth units 2a to 2h being driven based on a control command from the external control device, the posture of the robot 1 can be arbitrarily adjusted, such as by extending as shown in FIG. 1A, or contracting as shown in FIG. 1B. By so doing, a position or an orientation of the utility unit 4 can be controlled. Details of this will be described hereafter.

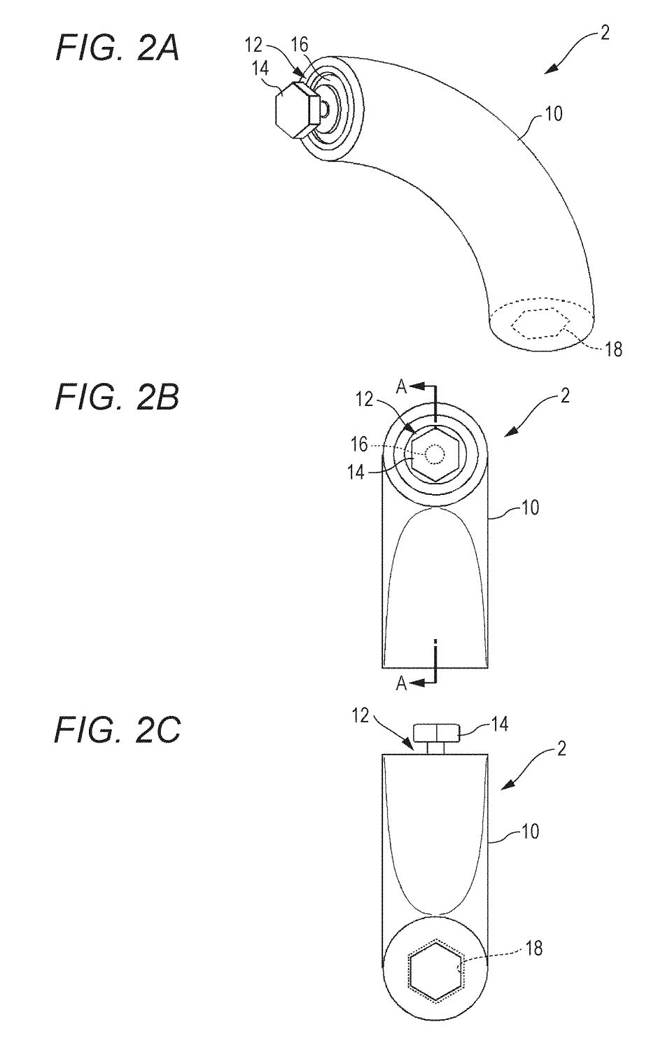

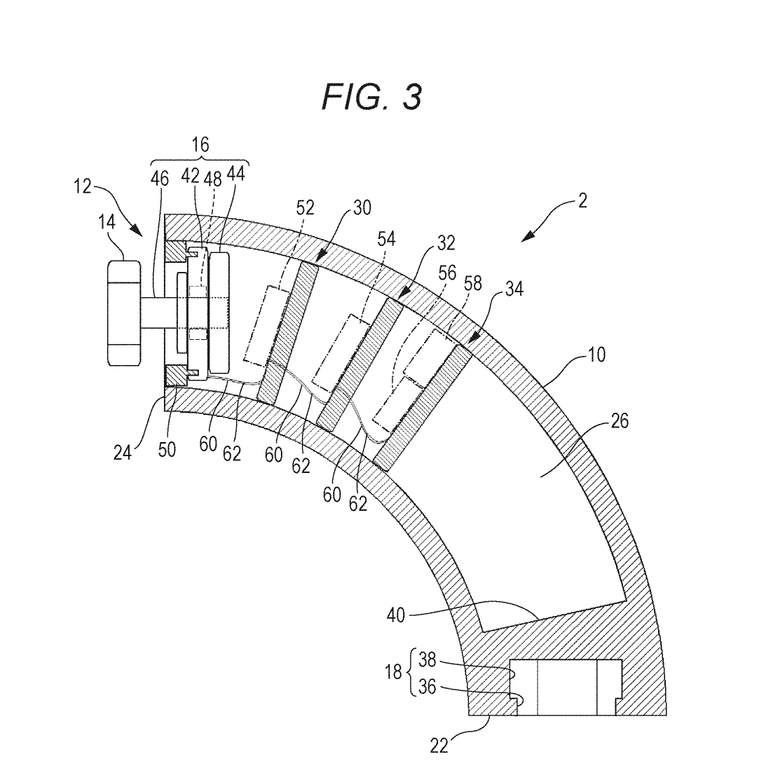

FIGS. 2A to 2C are drawings representing an external appearance of the unit 2. FIG. 2A is a perspective view, FIG. 2B is a front view, and FIG. 2C is a bottom view. FIG. 3 is a sectional view along an A-A arrow of FIG. 2B.

As shown in FIGS. 2A to 2C, the unit 2 includes a body 10 of a one-quarter arc form, and a drive mechanism 12 provided on one end side of the body 10. The drive mechanism 12 is an actuator including an operating member 14 coupled to the unit 2 in front, and a motor 16 that causes the operating member 14 to rotate.

The body 10 is formed of a material whose form is unlikely to change, such as metal or resin, and has a round (perfectly circular) cross-section and end face. The operating member 14 is formed of a plate body (metal plate) of a hexagonal form, and a central shaft thereof is integrated with a rotary shaft of the motor 16. A coupling portion 18 connected to the unit 2 behind is provided at the other end of the body 10. The coupling portion 18 functions as a “driven portion”, has an aperture portion of a hexagonal form in a center of the other end face of the body 10, and can receive the operating member 14 of another unit 2.

As shown in FIG. 3, the body 10 is of a largely cylindrical form, and has a form bent into a one-quarter arc in a longitudinal direction. A base end face 22 and a leading end face 24 of the body 10 are at right-angles to each other. A housing space 26 is formed in an interior of the body 10, and the motor 16, a control substrate 30, a communication substrate 32, and a power supply substrate 34 are housed so as to leave intervals in front and behind.

The coupling portion 18 forms a stepped hexagonal hole, and has a small diameter aperture portion 36 and a large diameter fitting portion 38. The aperture portion 36 is slightly smaller than the operating member 14, and the fitting portion 38 is slightly larger than the operating member 14. This kind of form is such that when the operating member 14 is coupled, the aperture portion 36 receives the operating member 14 while being somewhat pushed apart, and the fitting portion 38 fits securely. When the operating member 14 once fits into the coupling portion 18, the operating member 14 is locked so as to be caught on the step between the aperture portion 36 and the fitting portion 38, because of which a falling out of the operating member 14 is prevented. A partitioning wall 40 is provided between the coupling portion 18 and the housing space 26.

The motor 16 is an ultrasonic motor, and includes a stator 42, a rotor 44, an output shaft 46 (rotary shaft), and a shaft bearing 48. The stator 42 includes a piezoelectric body (piezoelectric ceramic) that generates oscillation, a base member that amplifies the oscillation, a sliding member that comes into contact with the rotor 44, and the like. The piezoelectric body transforms owing to voltage being applied, and the transformation is propagated while being amplified by the base member. Because of this, a surface of the piezoelectric body transforms into a wave form, becoming a progressive wave, and causes the rotor 44, which is in contact, to rotate owing to frictional force of the progressive wave. As a configuration and an operation of this kind of ultrasonic motor are commonly known, a detailed description thereof will be omitted.

The stator 42 is fixed to a holding member 50, and the holding member 50 is press-fitted into a leading end aperture portion of the body 10. By so doing, the motor 16 is securely supported by the body 10. The holding member 50 is of an annular form, and is mounted coaxially in the leading end aperture portion of the body 10. The stator 42 and the rotor 44 are supported coaxially by the holding member 50, and the output shaft 46 coaxially penetrates the holding member 50. Because of this, the operating member 14 is supported parallel with the leading end face 24 of the body 10.

A control circuit 52 for controlling rotation of the motor 16 is mounted on the control substrate 30. The control circuit 52 includes a processor and a storage device omitted from the drawing. The processor is computer program execution means. The storage device includes a volatile memory that successively stores and updates a rotary drive amount (an angle of rotation from a reference position) of the motor 16, and the like. A communication circuit 54 (a communication module) for communicating with the external control device is mounted on the communication substrate 32. A battery 56 for supplying power to each circuit, and a charging circuit 58 of the battery 56, are mounted on the power supply substrate 34. The substrates and the motor 16 are connected to each other by a power line 60 and a signal line 62. The battery 56 supplies power to each circuit and the motor 16 via the power line 60. Each circuit transmits and receives a control signal using the signal line 62. The battery 56 is a rechargeable battery such as a lithium ion battery. The charging circuit 58 executes charging of the battery 56 using a wireless power supply.

The body 10 is obtained by injection molding of a resin material using a split mold. That is, a left half portion and a right half portion of the body 10 are individually obtained by injection molding, and the drive mechanism 12, the control substrate 30, the communication substrate 32, and the power supply substrate 34 are mounted in one half portion as shown in the drawing. Subsequently, the unit 2 is obtained by assembling so as to cover the other half portion, and bonding, welding, or the like.

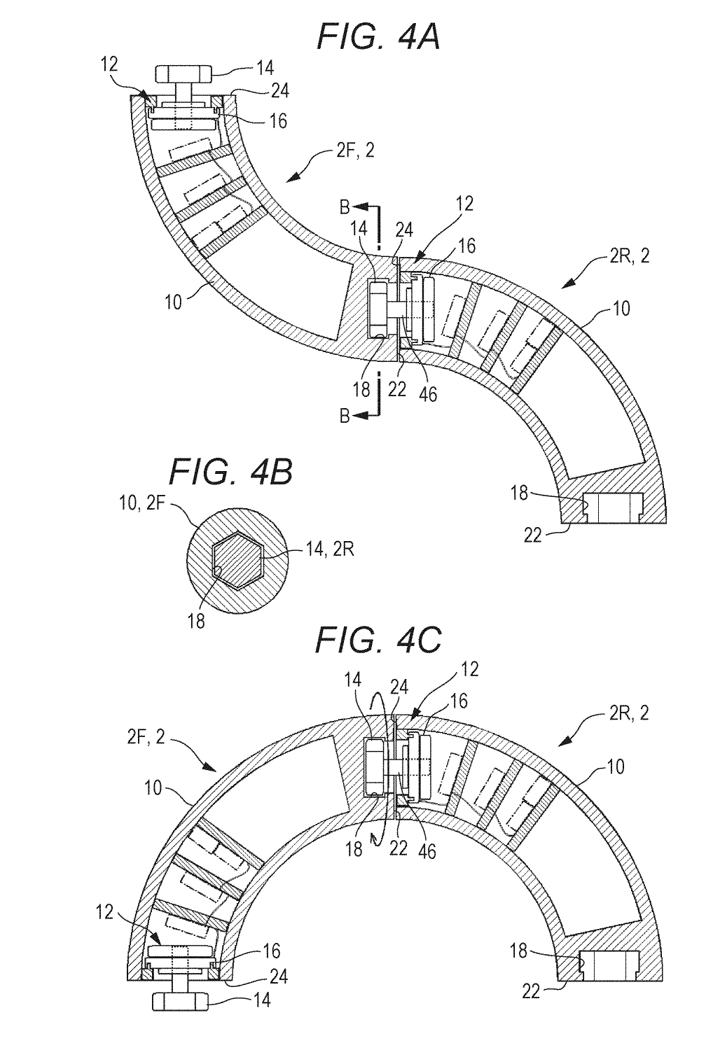

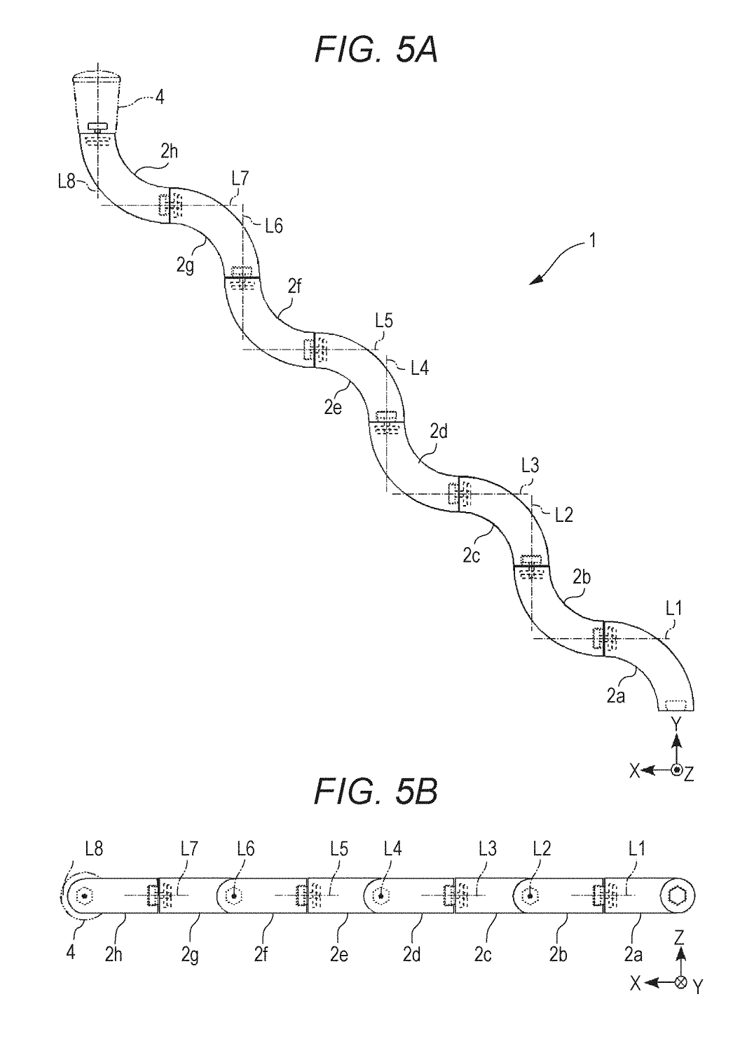

FIGS. 4A to 4C are sectional views representing a connection structure of the unit 2. FIG. 4A shows a state in which the rotary drive angle is 0 degrees (a reference state). FIG. 4B is a sectional view along a B-B arrow of FIG. 4A. FIG. 4C shows a state in which the rotary drive angle is 180 degrees. FIGS. 5A and 5B are schematic views representing a connection structure of the whole robot 1. FIG. 5A is a plan view, and FIG. 5B is a side view.

As shown in FIG. 4A, a front unit 2 (also referred to as a “front unit 2F”) and a rear unit 2 (also referred to as a “rear unit 2R”) are connected by a fitting of the coupling portion 18 and the operating member 14. The coupling portion 18 and the operating member 14 are detachable. As shown in FIG. 4B, the two are fitted so as to constrain each other in the direction of rotation owing to the hexagonal cross-sections, because of which a rotary drive force of the rear unit 2R can be reliably transmitted to the front unit 2F. When the motor 16 of the rear unit 2R is driven in one direction, the front unit 2F rotates centered on the output shaft 46 of the motor 16 as shown in FIG. 4C.

Since a front end face of the rear unit 2R and a rear end face of the front unit 2F are coaxial and perfectly circular, no change in form of a connection between the two in a diameter direction occurs during this rotation driving. Because of this, even if a user comes into contact with the connection portion, the user does not get sandwiched or caught. In this embodiment, the front end face of the rear unit 2R and the rear end face of the front unit 2F are coaxial and perfect circular, but may have similar shapes.

As shown in FIGS. 5A and 5B, the robot 1 is of a wave form in plan view and of a linear form in side view when in a most extended state. For the sake of convenience, an example wherein a vertical direction is a Z direction, and an XY-plane is taken perpendicular to the Z direction (an X direction and a Y direction are perpendicular to each other), is shown in the drawing, but it goes without saying that a three-dimensional coordinate space representing a position of the robot 1 may be set arbitrarily. Also, the position may be represented using polar coordinates rather than the kind of Cartesian coordinates shown in the drawing.

Rotary shafts L1 to L7 of the units 2 interconnected from the first unit 2a toward the eighth unit 2h are provided. Also, a rotary shaft L8 is also provided between the leading end eighth unit 2h and the utility unit 4. Each unit 2 can be relatively displaced (can pivot relatively) at a connection portion, and the robot 1 has a degree of freedom in accordance with the number of combinations of the rotary shafts. In this embodiment, the position of each unit 2 is set with the base end first unit 2a as a reference. Because of this, the posture of the robot 1 is adjusted, and the position and the orientation of the utility unit 4 are controlled.

In this embodiment, an optical axis of the LED of the utility unit 4 is caused to coincide with the rotary shaft L8. This means that even when causing the output shaft 46 of the eighth unit 2h to rotate, this does not contribute to controlling a light irradiation direction. In other words, there is no need to cause the eighth unit 2h to drive. In a modified example, the degree of freedom of the utility unit 4 may be further increased by causing the optical axis of the LED of the utility unit 4 to deviate from the rotary shaft L8.

By controlling absolute positions and relative positions of the first unit 2a to the eighth unit 2h, any interlocked units 2a are locked to each other, and a posture such that no rotational moment is generated around the rotary shaft of the connection portion of the two can be realized. For example, only the second unit 2b is caused to pivot 90 degrees counterclockwise in a YZ-plane from the state shown in FIG. 5A. By so doing, the units 2 interlocked on the leading end side of the second unit 2b push against each other at opposing faces thereof, and relative rotation is restricted by mutual frictional force. Because of this, the posture of the robot 1 can be maintained by a mechanical structure alone, without applying electrical power. The same applies when causing only the fourth unit 2d, the sixth unit 2f, or the eighth unit 2h to pivot 90 degrees from the state shown in FIG. 5A. That is, by turning off the power after controlling to this kind of specific posture, a state in which at least one portion of the robot 1 is caused to stand up from an installation surface (a floor surface or the like) can be maintained without energization. Because of this, power of the battery 56 can be saved.

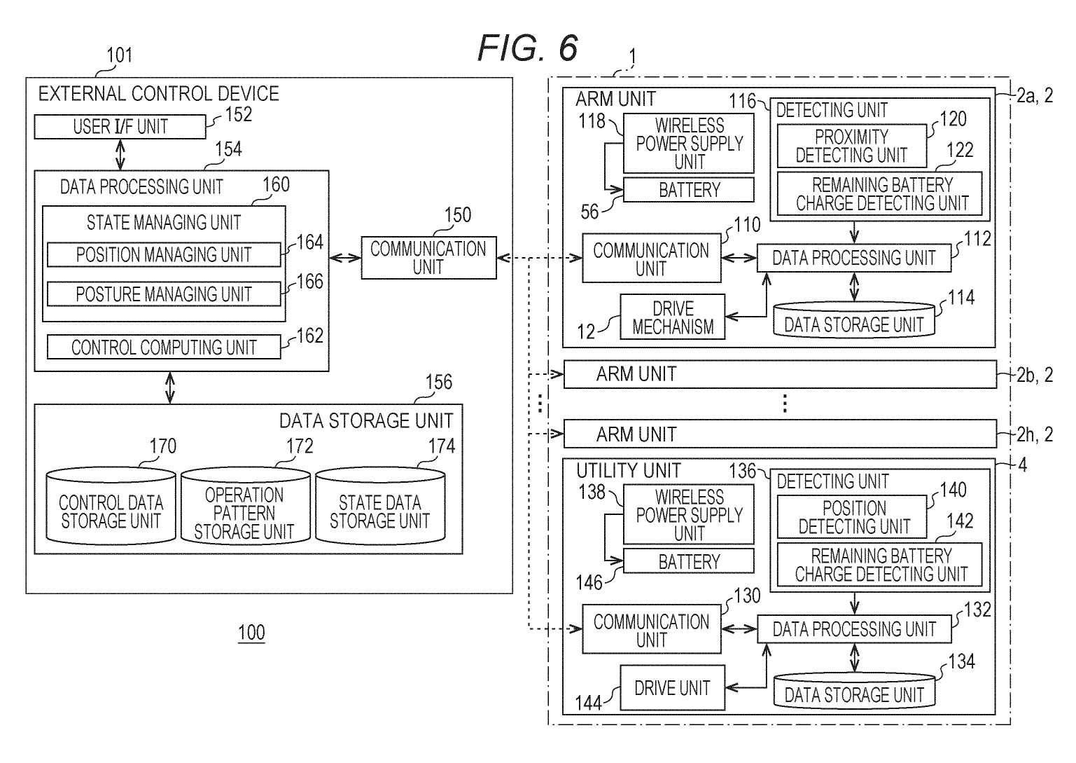

FIG. 6 is a functional block diagram of a robot device 100.

The robot device 100 includes the robot 1 and an external control device 101. Each component of the robot 1 and the external control device 101 is realized by hardware including a computer formed of a CPU (central processing unit), various kinds of coprocessor, and the like, a storage device that is a memory or storage, and a wired or wireless communication line that links the computer and the storage device, and software that is stored in the storage device and supplies a processing command to the computer. Each block described hereafter indicates a functional unit block rather than a hardware unit configuration.

The robot 1 and the external control device 101 can communicate wirelessly, and an operation of the robot 1 is controlled by the external control device 101. The external control device 101 may be a terminal such as a personal computer held by a user, or a server or the like. As heretofore described, the robot 1 includes the first to eighth units 2a to 2h (the units 2) and the utility unit 4.

Each unit 2 of the robot 1 regularly transmits a wireless signal including individually set ID. Information for identifying the position of the unit 2 (hereafter referred to as “position identifying information”) is included in the wireless signal. Information indicating a distance and a direction to a target object in accordance with an application of the robot 1, a position relative to the interconnected unit 2 (the angle of rotation from the reference position and the like), and the like, is included in the position identifying information. In a modified example, the position identifying information may be transmitted from the robot 1 when there is a request from the external control device 101.

The external control device 101 computes and manages the current position of the robot 1, and the position, posture, and the like of each unit 2, based on the signal transmitted from each unit 2. Further, the external control device 101 computes the posture the robot 1 should adopt in accordance with an input by a user, and computes the drive amount of each unit 2 for realizing the posture. The external control device 101 outputs a control command signal for each unit 2, including the ID of the unit 2. Each unit 2 receives the command signal corresponding to the ID of the unit 2 itself, and drives the drive mechanism 12 in accordance with the command details. Because of this, the robot 1 is controlled in accordance with a request from the user, and can achieve an object thereof. Details of a specific control method of this kind of robot 1 will be described hereafter.

Robot 1

Arm Unit

The unit 2 of the robot 1 includes a communication unit 110, a data processing unit 112, a data storage unit 114, a detecting unit 116, and a wireless power supply unit 118 (a power supply circuit). The communication unit 110 manages a process of communicating with the external control device 101. The data storage unit 114 includes the heretofore described storage device, and successively stores data such as the angle of rotation of the motor 16. The data processing unit 112 includes the heretofore described processor, and executes various kinds of process, such as controlling the drive mechanism 12, based on a control command received via the communication unit 110.

The detecting unit 116 includes a proximity detecting unit 120 and a remaining battery charge detecting unit 122. The proximity detecting unit 120 includes a proximity sensor, and detects a proximity or a contact between the unit 2 and an external object. A high frequency oscillation type of sensor that utilizes electromagnetic induction, an electrostatic capacitance type of sensor that detects a change in electrostatic capacitance between the unit 2 and the object, a magnetic type of sensor that uses a magnet, or the like, can be used as the proximity sensor.

The remaining battery charge detecting unit 122 detects a remaining charge of the battery 56. When the remaining battery charge drops to or below a predetermined value, the data processing unit 112 issues a charging command to the wireless power supply unit 118. The wireless power supply unit 118 charges the battery 56 using a wireless power supply method. In this embodiment, an electromagnetic field resonance method, whereby a comparatively large power transmission distance is obtained, is employed.

The wireless power supply unit 118 includes a power receiving unit, a rectifying circuit, a stabilizing circuit, a charging circuit, and the like, which are omitted from the drawings. The power receiving unit includes a power receiving coil (secondary side coil), a resonance capacitor, and the like, and receives alternating current power transmitted from an unshown power transmitting device. The alternating current power is rectified in the rectifying circuit, becoming direct current power, and voltage stabilization is carried out in the stabilizing circuit. The charging circuit carries out a charging of the battery 56 using the stabilized power.

The power transmitting device includes a power transmitting coil (primary side coil), a resonance capacitor, and the like, generates high frequency power (an alternating current signal) using power supplied from an external power source, and carries out a power transmission. The external power source may be, for example, a power supply of a universal serial bus (USB) provided in the external control device 101 (a personal computer or the like). Alternatively, a power transmitting device may be installed separately from the external control device 101. In a modified example, an electromagnetic induction method, an electric field coupling method, a radio wave method, or other wireless power supply method, may be employed. As every method is commonly known, a description thereof will be omitted.

Utility Unit

The utility unit 4 includes a communication unit 130, a data processing unit 132, a data storage unit 134, a detecting unit 136, and a wireless power supply unit 138. The utility unit 4 also includes a drive unit 144 that drives an LED or the like, and a battery 146 as a power source. The communication unit 130 manages a process of communicating with the external control device 101. The data storage unit 134 includes a storage device, and temporarily stores data imaged by a camera to be described hereafter, and the like. The data processing unit 132 includes a processor, and executes various kinds of process, such as controlling the drive unit 144 based on a control command received via the communication unit 130.

The detecting unit 136 includes a position detecting unit 140 and a remaining battery charge detecting unit 142. The position detecting unit 140 includes a camera and a distance sensor. An optical axis of the camera is set so as to practically coincide with the optical axis of the LED. The distance sensor is formed of, for example, a time of flight (TOF) method sensor that detects a distance to a measurement target based on a phase difference between radiated light and reflected light, and detects a distance to an external target object. Light of the LED can be utilized as the radiated light. By referring to detection information of the distance sensor after a target object is identified by the camera, the distance from the utility unit 4 to the target object can be computed. Also, by the position of the target object being set as an origin of a three-dimensional space, the position and the posture of the robot 1 can be calculated back, and information on the position and the posture can be utilized in control of the robot 1. Details thereof will be described hereafter.

The remaining battery charge detecting unit 142 detects a remaining charge of the battery 146. When the remaining battery charge drops to or below a predetermined value, the data processing unit 132 issues a charging command to the wireless power supply unit 138. The wireless power supply unit 138 charges the battery 146 using the same kind of wireless power supply method as the unit 2, but a different power supply method may be employed in a modified example.

External Control Device 101

The external control device 101 includes a communication unit 150, a user interface unit (hereafter written as a “user I/F unit”) 152, a data processing unit 154, and a data storage unit 156. The communication unit 150 manages a process of communicating with the robot 1. The user I/F unit 152 receives an operation input by a user via a keyboard or a touch panel, and manages a process relating to a user interface, such as a screen display. The data storage unit 156 stores various kinds of data. The data processing unit 154 executes various kinds of process based on data acquired by the communication unit 150 and data stored in the data storage unit 156. The data processing unit 154 also functions as an interface between the communication unit 150 and the data storage unit 156.

The data storage unit 156 includes a control data storage unit 170, an operation pattern storage unit 172, and a state data storage unit 174. The control data storage unit 170 stores a control program for controlling an operation of the robot 1 in accordance with an input by a user.

The operation pattern storage unit 172 stores various postures that can be realized by the robot 1, and an operation pattern (drive process) of each unit 2 for realizing the postures. The operation pattern can also be added to as appropriate using machine learning or the like.

The state data storage unit 174 stores and updates the current position and posture of the robot 1. More specifically, the state data storage unit 174 stores and updates the current position and drive amount (control amount) of each unit 2 correlated to the ID of the unit 2.

The data processing unit 154 includes a state managing unit 160 that manages a state of the robot 1, and a control computing unit 162 that controls a drive of the robot 1. The state managing unit 160 includes a position managing unit 164 and a posture managing unit 166. The position managing unit 164 manages position information of each unit 2 and the utility unit 4 configuring the robot 1. The position information can be identified from the rotary drive amount of each unit 2 having the first unit 2a as a reference. Specifically, the position information is managed as the positions of the connection portions of the interlocked units 2.

The posture managing unit 166 manages posture information (an external form) of the robot 1. The posture information can be identified from the heretofore described position information and the form (a one-quarter arc form in this embodiment) of the unit 2. The posture managing unit 166 can cause the current posture of the robot 1 to be displayed on a display device omitted from the drawings in response to a request from a user.

The control computing unit 162 specifies an operation pattern for causing the posture of the robot 1 to change in accordance with an input by a user, and computes the drive amount of each unit 2 based on the operation pattern. Further, the control computing unit 162 sequentially outputs a control command for each unit 2 in such a way as to be correlated with ID. In this embodiment, in order to maintain control stability, the units 2 are driven sequentially from the base end of the robot 1 toward the leading end (that is, from the first unit 2a toward the eighth unit 2h), rather than all the units 2 being driven simultaneously. Further, after the robot 1 attains a target posture and the utility unit 4 is oriented toward a target object (target region), the control computing unit 162 controls an illumination to indicate this.

Next, a method of controlling the robot 1 will be described.

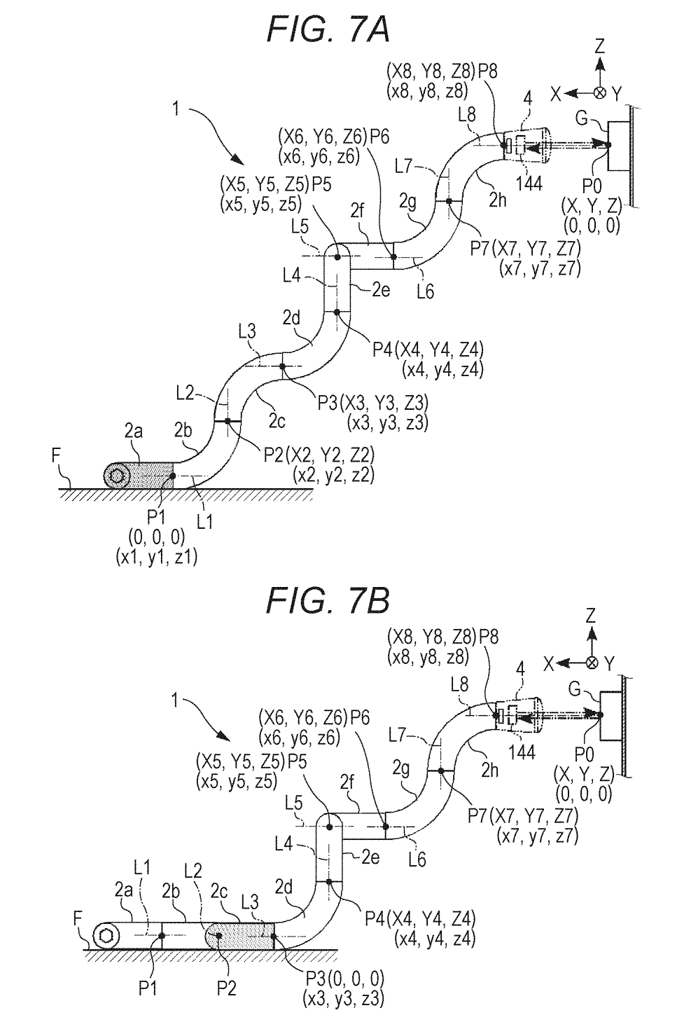

FIGS. 7A and 7B are drawings schematically representing a method of controlling the robot 1. FIGS. 7A and 7B show examples of a control process.

In order to cause the robot 1 to function as a lighting device, it is necessary to identify a position of a target object G to be irradiated with light. Meanwhile, as the robot 1 is configured as a moving object, an absolute position in a three-dimensional space is not fixed. Therefore, in this embodiment, control of the robot 1 is executed based on a relative positional relationship between the target object G and the robot 1. Specifically, the state managing unit 160 computes the position and the posture of the robot 1 with the position of the target object G as a provisional origin, and calculates a reference position for control of the robot 1. Further, the state managing unit 160 calculates back so that the calculated reference position becomes an origin for control computation, and specifies the position and the posture of each portion of the robot 1. Subsequently, each unit 2 is controlled with the origin for control computation as a reference.

That is, the kind of three-dimensional space coordinates shown in FIG. 7A are set, and provisional coordinates (x, y, z) of each unit with the position of the target object G as a provisional origin (0, 0, 0) are computed. Herein, the positions of the units are specified at connection points P1 to P8 between continuously connected units. As shown in the drawing, the connection points P1 to P8 are defined as the connection point P1 between the first unit 2a and the second unit 2b, the connection point P2 between the second unit 2b and the third unit 2c, and so on up to the connection point P8 between the eighth unit 2h and the utility unit 4.

The provisional origin is obtained by capturing the target object G using the camera of the utility object 4, and measuring distance. A point of intersection between the optical axis of the distance sensor (LED) and the target object G (that is, a center of light irradiation and reflection of the target object G) forms the “provisional origin”. In a state in which the drive unit 144 causes the utility unit 4 to confront the target object G, the position detecting unit 140 detects the distance between the utility unit 4 and the provisional origin, and transmits the distance as position information to the external control device 101.

When the external control device 101 receives the position information, the position managing unit 164 computes provisional coordinates (x8, y8, z8) of the connection point P8, which is on an axial line of the utility unit 4 from the provisional origin. Herein, information on the rotary drive amount (angle of rotation) of each unit 2 is stored in the state data storage unit 174, meaning that provided that the coordinates of one interlocked unit are known, the coordinates of the other unit can be calculated. Because of this, the position managing unit 164 retrieves the angle of rotation information, and sequentially calculates provisional coordinates (x7, y7, z7) to (x1, y1, z1) of each connection point in the order of connection points P7, P6, P5, P4, P3, P2, and P1.

When the coordinates (x1, y1, z1) of the base end connection point P1 are obtained in this way, the position managing unit 164 calculates back to obtain coordinates of the connection points P2 to P8, with the coordinates of the connection point P1 as an origin (0, 0, 0) for control computation. It is assumed that the first unit 2a, which has the connection point P1 on an axis of rotation, is in contact with a floor surface F (an installation surface) over a whole length of the first unit 2a. By adopting the base end connection point P1 as the origin (0, 0, 0) for control computation in this way, coordinates (X2, Y2, Z2) of the connection point P2 can be computed based on the angle of rotation of the second unit 2b, and coordinates (X3, Y3, Z3) of the connection point P3 can be computed based on the coordinates of the connection point P2 and the angle of rotation of the third unit 2c.

In the same way, the position managing unit 164 sequentially calculates coordinates (X4, Y4, Z4) to (X8, Y8, Z8) of the connection points P4 to P8. Further, the position managing unit 164 identifies control coordinates (X, Y, Z) of the target object G from the coordinates (X8, Y8, Z8) of the leading end connection point P8. The posture managing unit 166 computes the posture of the robot 1 based on the calculated coordinates of the connection points P1 to P8 and the form of each unit 2. The computation results are stored in the state data storage unit 174. The posture managing unit 166 causes the posture of the robot 1 to be displayed on a display device in response to a request from a user.

The control computing unit 162 executes a control in accordance with a request from a user based on the position information of each portion of the robot 1 obtained as heretofore described, and the position information of the target object G. For example, the control computing unit 162 executes a control such as moving the utility unit 4 nearer to the target object G. When doing so, the control computing unit 162 computes the rotary drive amounts of the second to eighth units 2b to 2h with the position of the base end first unit 2a (the position of the connection point P1) as a reference, and outputs command control signals for realizing this. Of two interlocked units 2, the unit on the base end side controls the unit on the leading end side, because of which the rotary drive amounts of the second to eighth units 2b to 2h are rotary control amounts of the first to seventh units 2a to 2g. Further, a command signal indicating the rotary control amount is output correlated to the ID of the unit 2 that is the control target.

On the robot 1 side, each unit 2 receives the control command signal to which the ID of that unit 2 is appended, and drives the drive mechanism 12 (motor 16). As already mentioned, the control command signals are transmitted sequentially from the control command signal corresponding to the base end side unit 2 in order to realize stable control of the robot 1. Because of this, the robot 1 is driven in order from the base end side unit 2. It goes without saying that depending on control details, there may be a unit 2 that is not driven.

Note that when, for example, the target object G is in a low position, there is a case in which it is sufficient that only leading end side (front half side) units 2 are driven. Therefore, the control computing unit 162 switches the unit 2 that forms the control reference. That is, when the first to third units 2a to 2c can be brought into contact with a surface, as shown in FIG. 7B, the third unit 2c, which is the farthest forward thereof, is adopted as the reference. Further, the coordinate system is set so that the connection point P3 driven by the third unit 2c forms the control origin (0, 0, 0).

By so doing, the computation amount up to identifying the position of the utility unit 4, and by extension the position of the target object G, with the connection point P3 as the origin (0, 0, 0) can be reduced, whereby a processing load of the state managing unit 160 can be reduced. Also, power consumption of the units 2 in contact with the surface can be restricted.

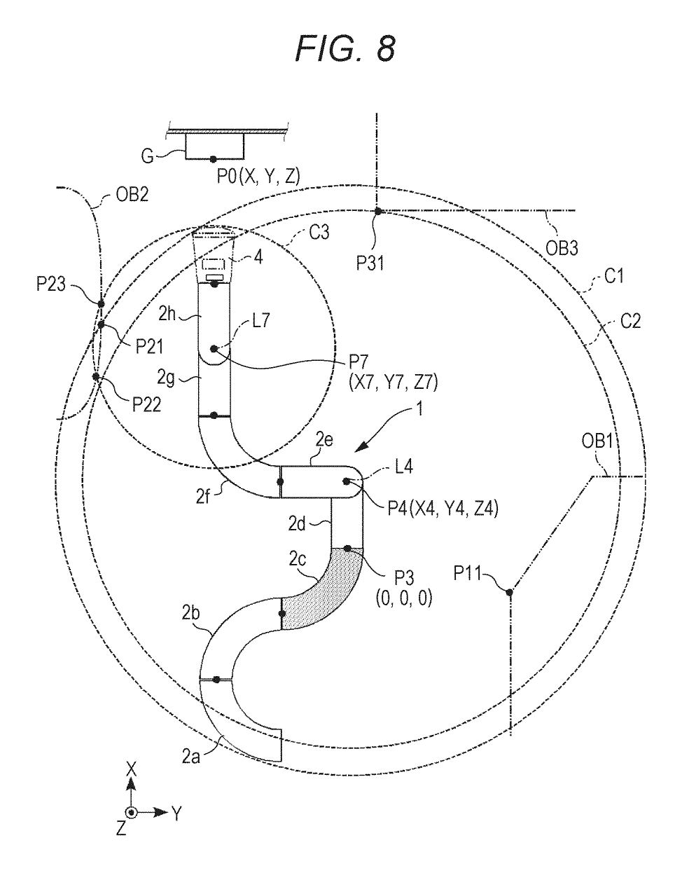

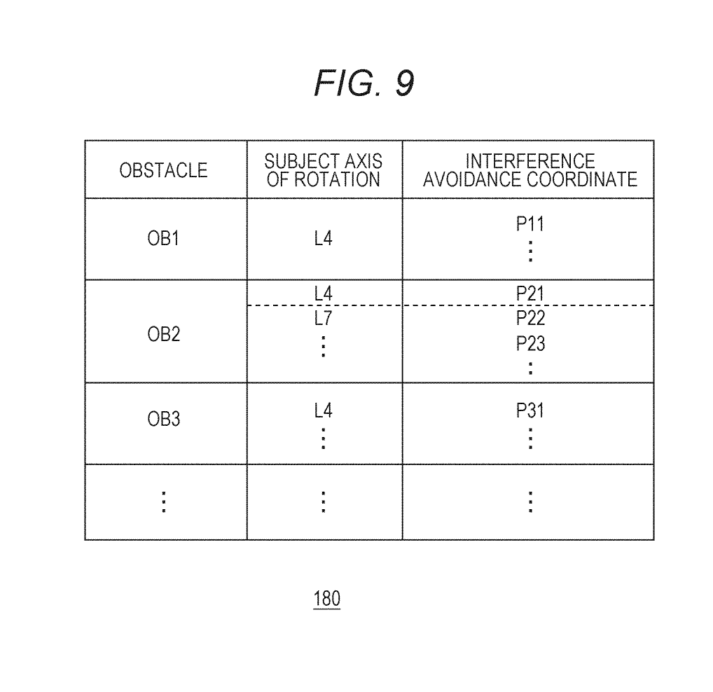

FIG. 8 is a drawing representing further details of the method of controlling the robot 1. FIG. 9 is a drawing representing an interference avoidance map used in a control computing process.

When computing the control amount as heretofore described, the control computing unit 162 computes so that the robot 1 does not interfere with an obstacle in the control process. For example, a case wherein obstacles OB1 to OB3, in addition to the target object G, are in a periphery of the robot 1 is envisaged, as shown in FIG. 8. FIG. 8 shows as an example a case in which the connection point P3 is the control origin (0, 0, 0), as shown in FIG. 7B.

In the example shown in the drawing, the connection points P4 and P7 have axes of rotation L4 and L7 that extend in a vertical direction. From the fifth unit 2e, the leading end side rotates centered on the axis of rotation L4, and from the eighth unit 2h, the leading end side rotates centered on the axis of rotation L7. Assuming provisionally that the eighth unit 2h is fixed and the fifth unit 2e is caused to rotate, the leading end of the utility unit 4 turns with the axis of rotation L4 as a turning axis, and a region of interference with an obstacle is formed inward of circles C1 and C2, which are orbits of the leading end. More specifically, a right turn movement limit is a point P31 of the obstacle OB3, and a left turn movement limit is a point P21 of the obstacle OB2. Because of this, an angle range between the point P21 and the point P31 is set as the control amount.

Assuming provisionally that the fifth unit 2e is fixed and the eighth unit 2h is caused to rotate, the leading end of the utility unit 4 turns with the axis of rotation L7 as a turning axis, and a region of interference with an obstacle is formed inward of a circle C3, which is an orbit of the leading end. In the example shown in the drawing, a right turn movement limit is a point P22 of the obstacle OB2, and a left turn movement limit is a point P23 of the obstacle OB2. Because of this, an angle range between the point P22 and the point P23 is set as the control amount. This is, of course, one example, and the angle range setting changes in accordance with the current position of the robot 1, a setting of the turning axis, and the like.

In order to realize this kind of control, the control computing unit 162 successively updates and holds a kind of interference avoidance map 180 shown in FIG. 9. The interference avoidance map 180 includes as parameters an obstacle, an axis of rotation for which the obstacle is an object of interference, a coordinate of the obstacle with which interference is to be avoided, and the like. In the example shown in the drawing, a point P11 is specified for the axis of rotation L4 with regard to the obstacle OB1 as the interference avoidance coordinate in closest proximity to the robot 1. Also, with regard to the obstacle OB2, the point P21 is specified for the axis of rotation L4, and the points P22 and P23 are specified for the axis of rotation L7. Furthermore, with regard to the obstacle OB3, the point P31 is specified for the axis of rotation L4.

This kind of interference avoidance map 180 is such that a specific posture is set in advance prior to control of the robot 1, each unit 2 is sequentially caused to rotate from the specific posture as an initial operation when starting control, and a movement limit may be set by searching using the distance sensor or the proximity sensor, or the like.

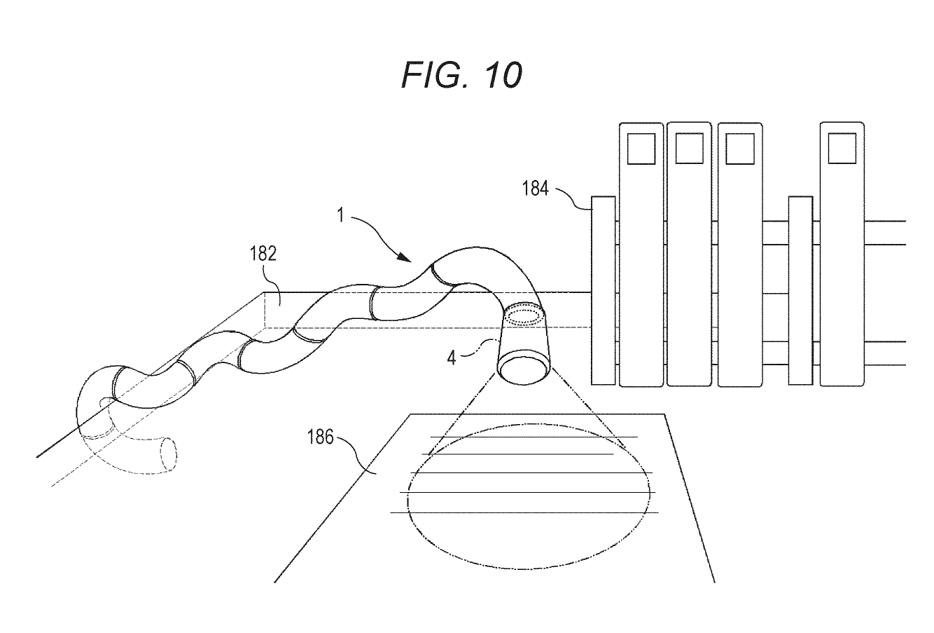

FIG. 10 is a diagram representing an example of using the robot 1.

In the example shown in the drawing, the robot 1 is caused to function as an electric light stand installed on a desk 182. By the heretofore described control being executed, the robot 1 can light writing 186, which is a target object, in a state in which interference with an obstacle such as a bookshelf 184 is avoided. A base end portion of the robot 1 is supported by being caught on a corner of the desk 182, whereby stable lighting is realized.

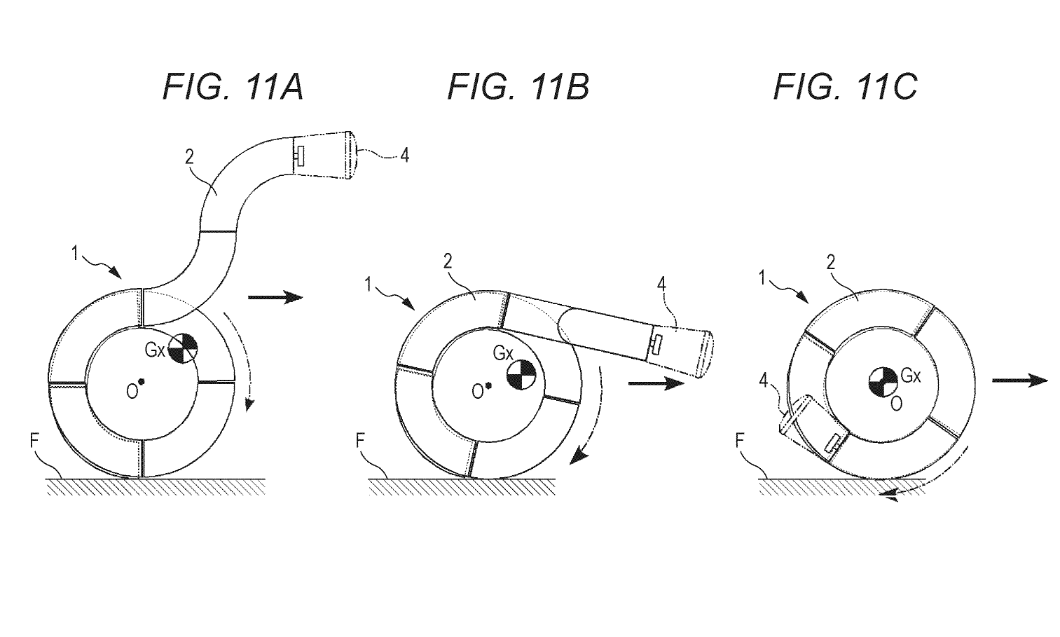

FIGS. 11A to 11C are drawings representing one example of a method of controlling movement of the robot 1. FIGS. 11A to 11C show a movement control process.

Various methods of moving the robot 1 are conceivable, but when an annular posture can be configured using a plurality of units 2, as in this embodiment, the robot 1 can be moved using a transmission control that utilizes the annular posture.

Specifically, the robot 1 is arranged in a coiled posture as shown in FIG. 1B, and an annular portion is stood on the floor surface F (refer to FIG. 11C). At this time, a center of gravity Gx of the robot 1 practically coincides with a center O of the annular portion. By a front portion of the robot 1 being raised up from this state, as shown in FIG. 11A, the center of gravity Gx deviates from the center O, and a forward rotational moment acts on the robot 1. Because of this, the robot 1 starts to move while rolling forward. By the front portion of the robot 1 being coiled in accordance with the rolling forward operation, the robot 1 can rotate owing to inertia thereof, without interfering with the floor surface F, as shown in FIGS. 11B and 11C. Movement of the robot 1 can be continued by repeating the control of FIGS. 11A to 11C.

According to the robot 1 of this embodiment, as heretofore described, interlocked units 2 have mutually coaxial and perfectly circular end faces in the connection portion thereof. Further, one of the units 2 is driven so as to rotate by the other unit 2, centered on the axial line of the connection portion. Because of this, no change in form of a joint portion (connection portion) occurs when the robot 1 is driven, and interference between the joint portion and an exterior (particularly a user) can be prevented.

As a unit having a curved (one-quarter arc form) external form is employed as the unit 2, the robot 1 does not extend to be perfectly straight (in a linear form), but a posture extending in one direction can easily be realized by controlling the angles of rotation of the multiple of units 2.

Also, as the multiple of units 2 are general-purpose units having a common structure, a cost reduction can be realized owing to a standardization of parts and molding dies, a reduction in manufacturing man-hours, and the like. Also, as it is sufficient to identify using ID, increasing or reducing the number of units is also easy. As a rotation operation is the same owing to general-purpose units being employed, switching or changing a control program in accordance with the number of units is also easy.

The invention not being limited to the heretofore described embodiment and modified examples, components can be modified and embodied without departing from the scope of the invention. Various inventions may be formed by appropriately combining a multiple of the components disclosed in the heretofore described embodiment and modified examples. Also, some components among all the components shown in the heretofore described embodiment and modified examples may be eliminated.

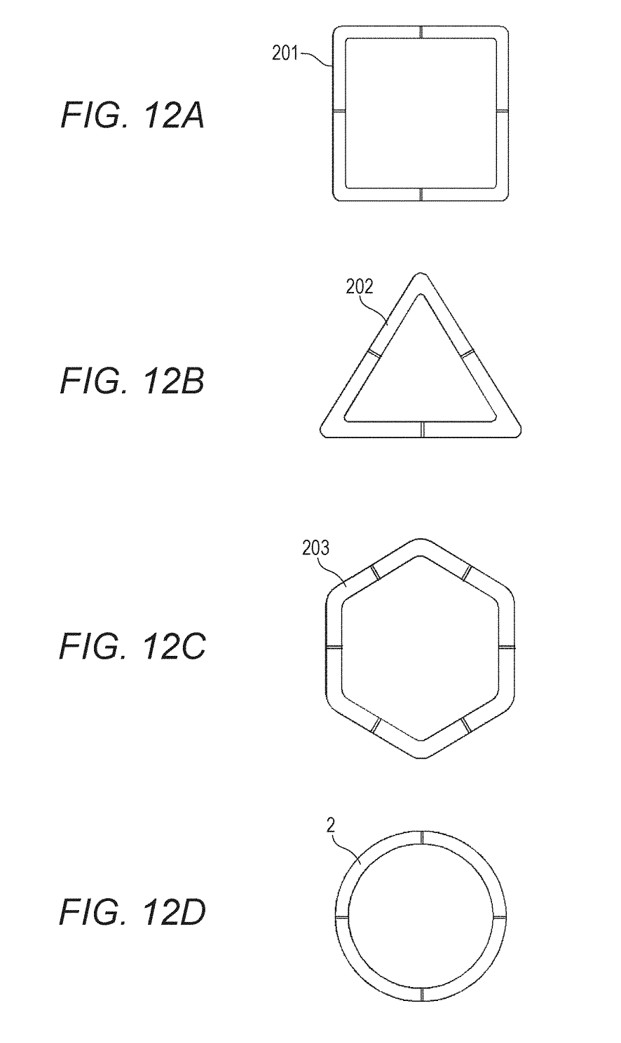

FIGS. 12A to 12D are drawings schematically showing a configuration of a robot according to modified examples. FIGS. 12A to 12C show modified examples, and FIG. 12D shows a configuration of the embodiment already described.

An example wherein the unit 2 is of a configuration such that a circular ring-form member is divided into four equal portions (that is, a one-quarter arc form), as shown in FIG. 12D, is shown in the heretofore described embodiment. In a modified example, for example, a configuration such that a rectangular ring-form member is divided into four equal portions (a unit 201) may be adopted, as shown in FIG. 12A. Alternatively, a configuration such that a triangular ring-form member is divided into three equal portions (a unit 202) may be adopted, as shown in FIG. 12B, or a configuration such that a hexagonal ring-form member is divided into six equal portions (a unit 203) may be adopted, as shown in FIG. 12C. Note that the units have mutually coaxial and perfectly circular end faces in a connection portion thereof. When adopting this kind of configuration too, an annular posture of the robot can be realized. Alternatively, a configuration other than this may be employed.

In the heretofore described embodiment, a description has been given assuming that the robot device 100 is configured of one robot 1 and one external control device 101, as shown in FIG. 6, but one portion of the functions of the robot 1 may be realized by the external control device 101, and one portion or all of the functions of the external control device 101 may be allocated to the robot 1. One external control device 101 may control a multiple of the robot 1, or a multiple of the external control device 101 may control one or more of the robot 1 in cooperation.

A third device other than the robot 1 and the external control device 101 may manage one portion of functions. A collection of the functions of the robot 1 and the functions of the external control device 101 described in FIG. 6 can also be comprehensively grasped as one “robot”. It is sufficient that a method of distributing the multiple of functions needed in order to realize the invention with respect to one or multiple items of hardware is determined with consideration to the processing capability of each item of hardware, specifications required of the robot device 100, and the like.

In the heretofore described embodiment, a “lighting device” is shown as an example of the utility unit 4. In a modified example, the utility unit 4 may be, for example, an imaging device such as a camera. Alternatively, the utility unit 4 may be a cutting or gripping device such as scissors or forceps. The utility unit 4 may be various other devices. Also, the multiple of units 2 themselves, depending on the postures thereof, may be caused to function as a gripping mechanism that grips an object. For example, the multiple of units 2 may be caused to function as an extra hand by being mounted on a user. Also, multiple kinds of the utility unit 4 may be prepared, and these may be attachable to and detachable from the robot 1. The utility unit 4 may be switchable in accordance with an application.

A configuration such that each of a multiple of arm units is controlled by an external control device is shown in the heretofore described embodiment. In a modified example, a master unit and a slave unit may be included as a multiple of arm units. Further, a configuration such that only a master unit carries out communication with an external control device may be adopted. That is, a master unit may include a communication unit for communicating with each of an external control device and a slave unit, and a control unit that computes a control command to be output to the slave unit based on a command from the external control device. The slave unit may include a communication unit for communicating with the master unit, and a drive unit that drives an interlocked arm unit based on a control command received from the master unit.

The slave unit includes a detecting unit that detects a rotational displacement from a reference position of the interlocked arm unit, and may transmit information indicating the detected rotational displacement to the master unit. The master unit may compute a control command for the slave unit based on information received from the slave unit. The master unit and the slave unit may be capable of switching reciprocal functions. Also, a multiple of slave units may be included as a multiple of arm units. The multiple of slave units may be capable of communicating with each other.

For example, a unit positioned in a predetermined position, such as the base end of the robot, may be caused to function as a master unit. The master unit receives a command from an external control device, and individually outputs a control command to another unit. The other unit functions as a “slave unit”, and drives the unit immediately in front based on the control command from the master unit. All the units have the same structure, regardless of whether the unit is a master or a slave, and may be “general-purpose units” that can be interchanged as appropriate. Whether a unit is a master or a slave is distinguished by ID set for each unit.

In the heretofore described embodiment, the forms of the units 2 are all the same, but units 2 of a multiple of differing forms may be combined. In this case, the unit 2 transmits correlating ID identifying the unit 2 itself and type ID identifying a type of the unit 2. The data storage unit 156 of FIG. 6 holds information on an external form of the unit 2, a positional relationship between the drive mechanism 12 and the coupling unit 18 that form a junction point, and the like, associated with the type ID. The control computing unit 162 refers to information relating to the external form associated with the type ID, and calculates the position of the unit 2. Because of this, the position can be accurately calculated even when units 2 of differing forms are coupled.

In general, torque of the motor 16 needs to be stronger for the unit 2 that forms a base portion than for a leading end portion to which the utility unit 4 is connected. The greater the torque of the motor 16, the larger an outer diameter of the unit 2 that houses the motor 16. Because of this, a form such that sizes of the outer diameters of the base end face 22 and the leading end face 24 of FIG. 3 are changed may be adopted. For example, the size of the outer diameter of the base end face 22 may be greater than the size of the outer diameter of the leading end face 24. Because of this, units of differing thicknesses can be smoothly connected.

Although not mentioned in the heretofore described embodiment, a power saving control mode that reduces a load on the drive mechanism 12 (motor 16) may be provided for a unit 2 among the multiple of units 2 in which the remaining charge of the battery 56 has dropped to or below the reference value. For example, the posture of the robot 1 may be controlled so that the current position of the relevant unit 2 is maintained by a mechanical structure alone owing to the positional relationship with the interlocked unit 2, as heretofore described. That is, the posture may be controlled so that essentially no electrical load is applied to the motor 16 of the relevant unit 2. In this case, the supply of power from the battery 56 of the relevant unit 2 may be turned off.

Although not mentioned in the heretofore described embodiment, the multiple of units 2 may be capable of wireless communication with each other. Alternatively, the multiple of units 2 may be capable of wired communication with each other. In this case, the power line and the signal line of one of consecutive units 2 may be drawn out in a form following the axial line of the connection portion, and connected to the power line and the signal line respectively of the other unit 2. In this case, each line may be connected to a so-called contact switch. In the case of a wired connection, a battery may be provided in only a specific unit, such as the base end unit 2.

In the heretofore described embodiment, the motor 16 is an ultrasonic motor, but the motor 16 may also be a stepping motor, DC motor, or other motor. Further, a brake structure for causing rotation of the motor to stop may be provided. For example, a drum-type brake, or the like, can be employed. Also, a so-called Harmonic Drive (registered trademark) may be employed for the drive of the motor. This drive is a wave gear device configured to include a wave generator, a flex spline, and a circular spline.

A configuration such that interlocked units 2 freely and relatively rotate centered on the rotary shaft (the output shaft 46) provided in the connection portion of the units 2, and one unit 2 incorporates the drive mechanism 12 for driving the other unit 2 so as to rotate (that is, the drive mechanism 12 is included in each unit 2), is shown as an example in the heretofore described embodiment. According to this kind of configuration, a range of movement of the robot 1 can be optimized by increasing or reducing the units 2 in accordance with the application of the robot 1. Because of this, a problem such as increasing versatility of a multi-jointed robot can be resolved. In this respect, the end faces of interlocked units 2 need not necessarily be coaxial and perfectly circular.

An example wherein the utility unit 4 includes a camera and a lighting device (LED) and lights the target object G, which is a target of light irradiation, is shown in the heretofore described embodiment (refer to FIGS. 7A and 7B and FIG. 8). The target object G may be a stationary object or region, or may be a moving object. The multiple of units 2 may be controlled so that the utility unit 4 can irradiate with light while tracking the moving object with the camera.

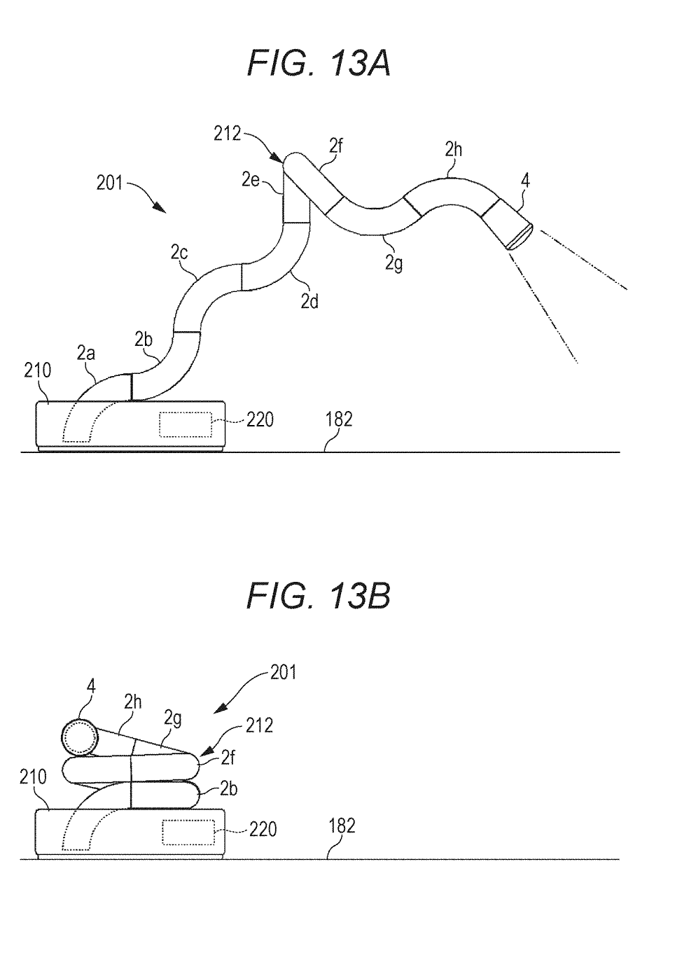

FIGS. 13A and 13B are drawings schematically representing a configuration and a control method of a robot according to a modified example. FIGS. 13A and 13B show an example of a control process.

In this modified example, a robot 201 is configured as an electric light stand. The electric light stand constantly lights a region of a hand of a user working at a desk, and adjusts an irradiated position so that even when the user's hand moves, the region of the hand does not become dark. The robot 201 has a base 210 that can be installed on a desk, and a robot main body 212 fixed to the base 210. The base 210 may include a fixing mechanism for fixing to the desk. The robot main body 212 has the same configuration as the robot 1 of the heretofore described configuration, and the base end first unit 2a is fixed to the base 210.

The base 210 incorporates a control device 220. The control device 220 has the same configuration as the external control device 101 of the heretofore described embodiment. The control device 220 has the state managing unit 160 and the control computing unit 162 (refer to FIG. 6). The state managing unit 160 functions as a “recognizing unit”, and recognizes a target object (moving object) that is a light irradiation target, and a shadow thereof, based on an image filmed by the camera of the utility unit 4. The control computing unit 162 functions as a “control unit”, and controls each unit 2 based on a direction of movement of the moving object and a direction of the shadow.

The robot 201 is installed on the kind of desk shown in FIG. 10. The base 210 is placed in a position in which the base 210 is not in the way of a user, such as a corner portion of the desk 182, and the robot main body 212 protrudes from an upper face of the base 210. The robot 201 maintains a coiled posture (a standby state), as in FIG. 13B, while not detecting a target object. At this time, the LED is in an off-state.

When a target object approaches to within a predetermined radial distance from the utility unit 4, the robot 201 detects this, shifts to an LED on-state mode, and causes the robot main body 212 to extend. For example, the state managing unit 160 has an infrared sensor, and when detecting a heat source using the infrared sensor, starts up the camera and starts an imaging process. When a user heading toward the desk is detected by the imaging process, the state managing unit 160 causes the robot main body 212 to extend. Also, when the user moves away from the desk and a certain period elapses, the robot 201 returns to the standby posture. In this way, the robot 201 operates in two modes, those being the standby mode in the coiled posture and the irradiating mode in the protruded state, and the mode switches in accordance with a presence or otherwise of a user.

In the irradiating mode, the robot 201 detects a fingertip of a user (corresponding to a “moving object”, this may also be a leading end of a pen held by the user) based on the imaging process, and irradiates with light so that a periphery of the fingertip is constantly light. The robot 201 identifies a direction of movement of the fingertip by tracking the fingertip, and controls each unit 2 based on the direction of movement of the fingertip and a direction of a shadow. Specifically, the robot 201 irradiates with light while controlling each unit 2 so as to adjust the position and the angle of the utility unit 4, so that the direction of movement of the fingertip and the direction of the shadow (the direction in which the shadow extends) practically coincide. Also, the robot 201 may control each unit 2 so that a range of the shadow is minimized, and irradiate with light.

According to this kind of control, a near side of a tip of a pen held by a user can be kept light, because of which efficiency of writing work of the user can be increased. At this time, for example, a size of the shadow may be reduced, or the shadow itself is made unlikely to appear, by controlling so as to keep a length of the shadow within a predetermined range. Also, by recognizing a face of a user, the angle of the utility unit 4 may be controlled so that light is not directed toward an eye of the user. Of course, control is carried out so that the robot 201 does not impede a line of sight of a user.

The state managing unit 160 of the control device 220 has a microphone (not shown), and may function as a “speech recognizing unit” that recognizes a voice (instruction) of a user. The robot 201 of this modified example automatically recognizes a fingertip of a user, and lights a periphery of the fingers, but there is a case in which adjustment of the irradiated position in accordance with the situation becomes necessary. In this case, the robot 201 recognizes speech by the user giving a verbal instruction such as “right a little” or “up a little”, and adjusts the illuminated position in the direction instructed. Also, the robot 201 identifies a target object based on an instruction from a user, and may control so that the target object is irradiated with light. For example, when a user is assembling a model, lighting is controlled so as to track the model rather than the fingertip of the user when the user gives an instruction such as “light the model” or “here”. When the user gives an instruction for continuity, such as “keep lighting here” or “lock it here”, the robot 201 may stop tracking, and continue lighting the place. When utilizing as this kind of electric light stand too, each unit 2 is controlled using the method described using mainly FIGS. 5A and 5B and FIGS. 7A and 7B, thereby restricting power consumption.

An example wherein the robot 1 includes three or more units 2, and all the units 2 are drive arm units incorporating the drive mechanism 12, the battery 56, and a power supply circuit (the wireless power supply unit 118), is shown in the heretofore described embodiment. In a modified example, one portion of the units 2 need not include one of the above components.

The battery 56 can be individually charged wirelessly in each drive arm unit. An order of priority for an order of charging may be provided for the multiple of drive arm units. For example, the smaller the remaining charge in a unit, the higher the order of priority may be. Alternatively, higher priority may be given to charging the nearer a unit is to the utility unit 4. By so doing, a minimum necessary function of the utility unit 4 can easily be fulfilled for a long time.

In the heretofore described embodiment, power consumption of the unit 2 in contact with a surface can be restricted, as described in connection with FIG. 7B. The data processing unit 132 of each unit 2 functions as an “energization control unit” that controls a supply of power from the corresponding battery 146. The proximity detecting unit 120 functions as a “surface contact detecting unit” that detects a surface-contacting state (a presence or otherwise of surface contact) of the corresponding unit 2. Specifically, the data processing unit 132 may shift to a power saving mode wherein the supply of power from the corresponding battery 146 to each circuit (the control circuit 52, the communication circuit 54, and the like) and the drive mechanism 12 is reduced or interrupted, under a predetermined condition, when the corresponding unit 2 is in a surface-contacting state. The power saving mode may be a so-called sleep state (standby) or a deactivated state. The power saving mode may also be such that the supply of power to a component other than the control circuit 52 is interrupted. Alternatively, the power saving mode may be such that the supply of power to the control circuit 52 is held at a standby power, which is lower than a steady-state power at a time of normal operation. The power saving mode may also be such that the steady-state power is supplied intermittently. The power saving mode may also be such that a clock supplied to the CPU of the control circuit 52 is temporarily interrupted.

For example, the data processing unit 132 may shift to the power saving mode under a condition that the unit 2 in front (on the utility unit 4 side) is in a surface-contacting state. At this time, interlocked units 2 can communicate directly with each other, and may confirm surface contact information. Alternatively, interlocked units 2 may share each other's surface contact information via a control device (the external control device 101 or the control device 220). According to this kind of configuration, power consumption of any unit 2 can be reduced in accordance with work details or an operating state of a multi-jointed robot, whereby energy efficiency of the multi-jointed robot can be increased.

An electric light stand is shown as an example of a multi-jointed robot in the heretofore described embodiment, but it goes without saying that the multi-jointed robot can also be configured as a manipulator or other multi-jointed robot.

What is claimed is:

1. A robot comprising:
a plurality of arm units configured to be continuously connected, wherein each arm unit of the plurality of arm units has a same curved external form, and each arm unit of the plurality of arm units comprises:
a first circular end face,
a second circular end face coaxial with the first circular end face, wherein the second circular end face of a first arm unit of the plurality of arm units is configured to detachably connect to the first circular end face of a second arm unit of the plurality of arm units;
a rotary shaft configured to rotate each of the first circular end face and the second circular end face, wherein the rotary shaft protrudes from a center of at least one of the first circular end face or the second circular end face, and the plurality of arm units is configured to realize a spiral posture by controlling an angle of rotation of the rotary shaft in at least one arm unit of the plurality of arm units; and
a utility unit detachably connectable to the first end face of the first arm unit.

2. The robot according to claim 1, further comprising a sensor for detecting whether a detection target is in proximity to the robot.

3. The robot according to claim 1, further comprising a sensor for detecting whether a detection target is in contact with at least one arm unit of the plurality of arm units.

4. The robot according to claim 1, wherein the robot is configured to move by changing a center of gravity of the plurality of arm units by changing a relative orientation of adjacent arm units of the plurality of arm units.

5. The robot according to claim 1, wherein at least one arm unit of the plurality of arm units further comprises a battery configured to supply power to a drive mechanism of an adjacent arm unit of the plurality of arm units.

6. The robot according to claim 1, wherein the at least one arm unit further comprises a power supply circuit for charging the battery.

7. The robot according to claim 1, wherein the first arm unit is configured to interlock with the second arm unit by a pressing force of opposing faces caused by gravitational force owing to absolute positions and relative positions of the first arm unit and the second arm unit.

8. The robot according to claim 1, wherein the first arm unit and the second arm unit are configured to realize a posture free of a rotational moment about an axial line at the second circular end face of the first arm unit.

9. The robot according to claim 8, wherein the first arm unit comprises a power supply, and the second arm unit is free of the power supply.

10. The robot according to claim 9, wherein in the posture power supply from the first arm unit to the second arm unit is configured to be interrupted.

11. The robot according to claim 1, wherein the utility unit includes at least one of a camera or a light source.

12. The robot according to claim 1, wherein the plurality of arm units are configured to maintain a contracted spiral posture in a standby mode.

13. The robot according to claim 1, wherein the plurality of arm units are configured to be arranged in an extended posture in an irradiating mode.

14. The robot according to claim 1, wherein utility unit comprises a light source and a camera, and
the plurality of arm units are controllable so that the utility unit is able to irradiate an object with the light source while capturing an image of the object with the camera.

15. The robot according to claim 14, comprising:
a processor configured to execute instructions for:
recognizing a shadow in a periphery of the object based on the captured image; and
controlling each of the plurality of arm units for decreasing a size of the shadow.

16. A robot comprising:
a plurality of arm units, wherein each of the plurality of arm units is detachably connectable to other arm units of the plurality of arm units, and each of the plurality of arm units have a same curved shape;
a utility unit detachably connectable to a first arm unit of the plurality of arm units;
a processor configured to execute instructions for controlling each arm unit of the plurality of arm units to selectively orient the robot in a plurality of postures.

17. The robot according to claim 16, wherein utility unit comprises a light source and a camera, and
the processor is configured to execute the instructions for controlling the plurality of arm units so that the utility unit is able to irradiate an object with the light source while capturing an image of the object with the camera.

18. The robot according to claim 17, wherein the processor is further configured to execute instructions for:
recognizing a shadow in a periphery of the object based on the captured image; and
controlling each of the plurality of arm units for decreasing a size of the shadow.

19. A method of operating a robot comprising:
controlling a plurality of arm units to selectively orient the robot in a plurality of postures, wherein each arm unit of the plurality of arm units is detachably connectable to other arm units of the plurality of arm units, and each of the plurality of arm units comprises a same curved shape;
irradiating an object using a light source in a utility unit detachably connected to an arm unit of the plurality of arm units; and
capturing an image of the object using a camera in the utility unit.

20. The method according to claim 19, further comprising:
recognizing a shadow in a periphery of the object based on the captured image; and
controlling each of the plurality of arm units for decreasing a size of the shadow.
